(19) United States
(12) Patent Application Publication
(10) Pub. No.: US 2009/0011156 A1
(43) Pub. Date: Jan. 8, 2009

(54) MULTIUSE DECALS WITH RUBBER-BASED HOT MELT ADHESIVE

(76) Inventor: Oscar af Strom, Atizapan (MX)

Correspondence Address: PATWRITE LLC, 408 W. MAIN ST., MARSHALLTOWN, IA, 50158-5759, US

(21) Appl. No.: 12/168,873

(22) Filed: Jul. 7, 2008

Related U.S. Application Data
(60) Provisional application No. 60/948,347, filed on Jul. 6, 2007.

(51) Int. Cl. B32B 27/00; B41M 5/41; B41M 5/42

(52) U.S. Cl. 428/32.81; 156/280

(57) ABSTRACT

Composite sheets for image transfer, having layers of rubber-based hot melt adhesive are positioned with the adhesive in contact with images. The support sheets are removed and the image paper backing washed away. The resultant decals may be ironed-on, pasted-on, and have the ability to adhere removeably to walls and windows, and adhere permanently to painted surfaces.

### RELATED APPLICATIONS

This application claims priority and herein incorporates by reference U.S. provisional patent application 60/948,347, filed Jul. 6, 2007.

### BACKGROUND OF THE INVENTION

In my patent application Ser. No. 10/783,971 filed on Feb. 20, 2004 and Ser. No. 11/465,446 filed on Aug. 17, 2006, demonstrated how to use decals, derived from composite sheets, consisting of a releasable support sheet, adhering to a plastic film, which other side adheres to a rubber based hot melt contact adhesive. The demonstration has mainly related to use of the decals for iron-on and paste on applications of said decals.

For such applications, the support sheet, releasably adhering to the plastic film, is not removed until the decal has been applied on the desired surface. This is due to the fact that it was believed that the decal would become too delicate to handle without a support sheet. This is true in respect of decals with very thin plastic films derived from acrylic emulsions. However, decals with 1 mil polyurethane plastic films can easily be handled without said support sheet.

When this fact was realized, the transfer process was changed, and the support sheet removed, once the composite sheet had been applied over the image. When the decal has a dry releasable support sheet, such as a silicone coated paper or silicone coated PET sheet, the support sheet may be removed immediately following application of the composite sheet on the image. When the support sheet is a wet release sheet, such as a one-side-coated paper, the support sheet can be peeled off after 5-10 minutes submersion of the laminate.

When the image paper backing has been washed off, the remainder of the laminate becomes a thin decal, consisting of a plastic film, adhering to the adhesive, which other side adheres to the image layer. If the image was located on a coated paper, the decal image layer will be covered by a thin paper coating layer, making it non-tacky. However, if the image was located on a thin magazine paper, the decal reverse image will become sticky, due to adhesive penetrating the layer. If the decal is to be applied later on, the image has to be covered by, for instance, a layer of talcum powder, or placed on a silicone coated release paper

### SUMMARY OF THE INVENTION

Composite sheets for image transfer, having layers of rubber-based hot melt adhesive are positioned with the adhesive in contact with images. The support sheets are removed and the image paper backing washed away. The resultant decals may be ironed-on, pasted-on, and have the ability to adhere removeably to walls and windows, and adhere permanently to painted surfaces.

Other features and advantages of the instant invention will become apparent from the following description of the invention which refers to the accompanying drawings.

### BRIEF DESCRIPTION OF THE DRAWINGS

FIG. 1 shows the cross section of a typical composite sheet in accordance with the invention

FIG. 2 shows the cross section of the composite sheet of FIG. 1, positioned over an image located on a coated paper.

FIG. 3 shows the cross section of the laminate of FIG. 2, after removal of the composite sheet support sheet

FIG. 4 shows the cross section of the decal derived from the laminate of FIG. 3.

FIG. 5 shows the cross section of the decal, clinging to a wall or a window.

FIG. 6 show the cross section of the decal with its rear layer covered by a coated film

FIG. 7 shows the decal of FIG. 6, with the coated film of acrylics, integrated in a layer of paint.

### DETAILED DESCRIPTION OF THE INVENTION

In the following detailed description of the invention, reference is made to the drawings in which reference numerals refer to like elements, and which are intended to show by way of illustration specific embodiments in which the invention may be practiced. It is understood that other embodiments may be utilized and that structural changes may be made without departing from the scope and spirit of the invention.

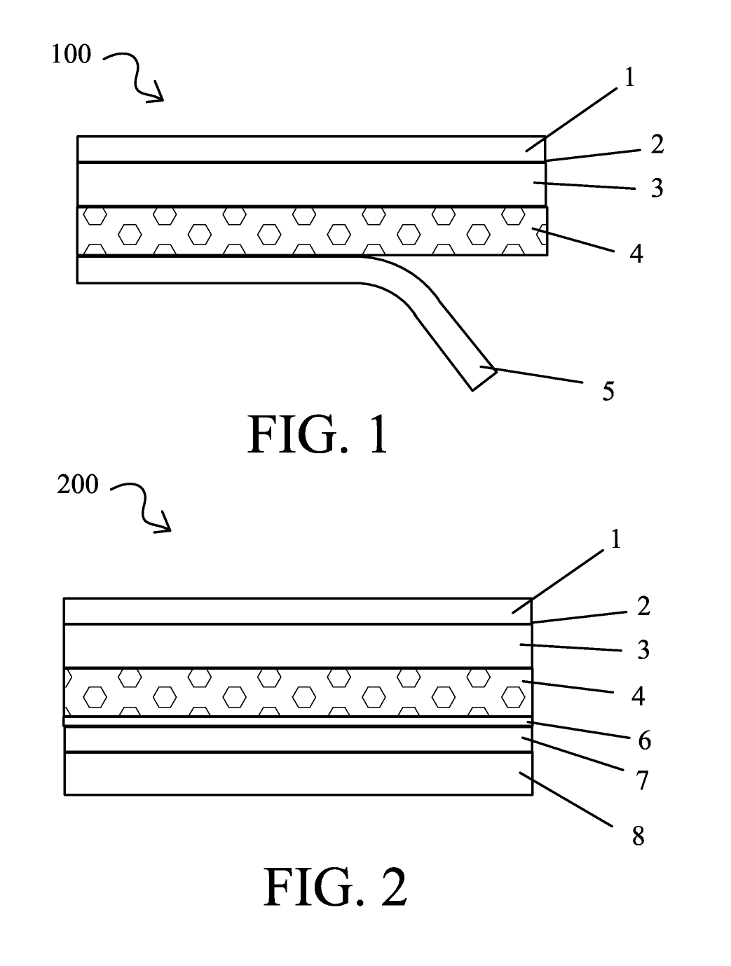

FIG. 1 shows a cross section of a typical composite sheet 100 in accordance with this invention. A support sheet 1 is releasably attached to a plastic film 3 using a release layer 2. Plastic film 3 opposite side adheres to a rubber-based hot melt adhesive layer 4, while the other side is protected by a release liner 5.

FIG. 2 shows the cross section of the composite sheet of FIG. 1 200, applied with adhesive 4 in contact with an image 6, located on a paper coating 7 of a paper 8. The image actually integrates with the rubber-based hot melt adhesive layer 4 through molecular migration producing a very durable decal.

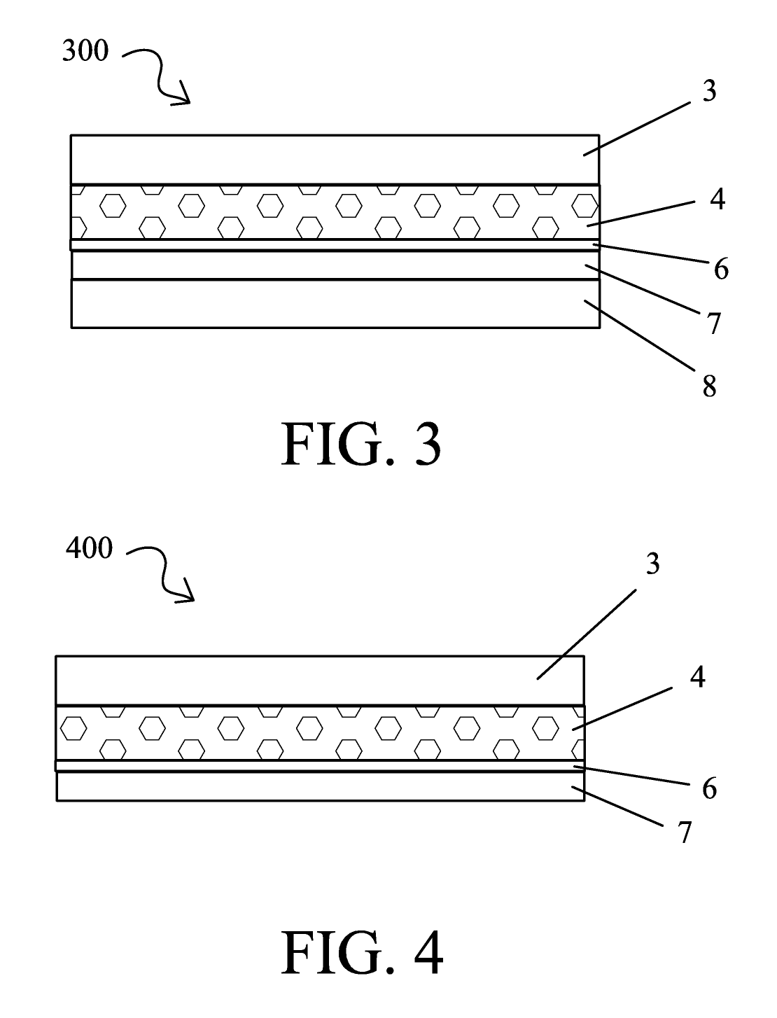

FIG. 3 shows the laminate of FIG. 2 300, after removal of support sheet 1.

FIG. 4 shows the decal 400 derived from the laminate of FIG. 3, after submersion of laminate 4 and removal of paper 8, with paper coating 7 covering image 6, preventing the same from becoming tacky.

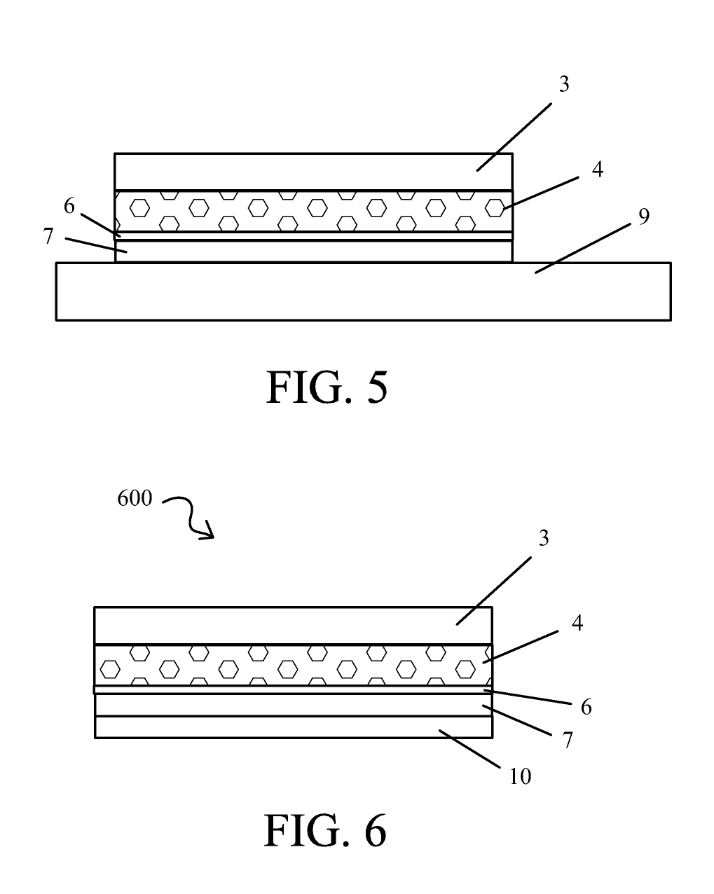

FIG. 5 shows the decal 400 of FIG. 4, clinging to a wall or a window 9. Molecular attraction allows decal 400 to remain adhered for prolonged periods of time even after dry.

FIG. 6 shows the decal 400 of FIG. 4 with a film 10 coated over paper coating 7 on its rear side. Coating 7 may be a polymer coating used to reinforce the integration into a painted layer. Of course it could also be a protective layer, preventing this from happening, making it possible to removeably apply decal 400 on painted surfaces.

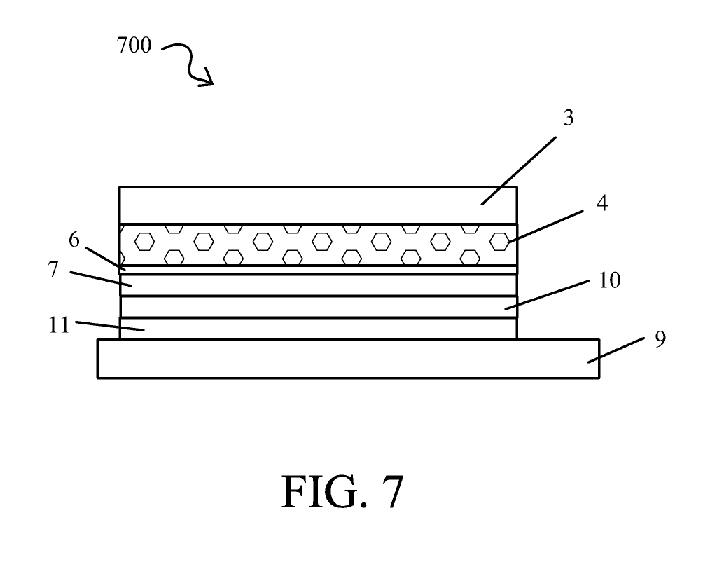

FIG. 7 shows decal coated layer 10, integrated into a painted layer 11.

Testing

Ex. 1: A window was decorated at Christmas with decals, derived from color laser copies on a coated paper of images of Santa Clause, angles, slay and reindeers. A composite sheet in accordance with this invention was positioned with the adhesive in contact with the copied images. The support sheets were removed, after which the image paper backings were washed away, and the resultant decals trimmed to the desired shape. The rear side of the decals were then coated with an acrylic emulsion, making the decals completely clear and visible from either side. Finally, the decals were wetted and positioned on the window.

Ex. 2: A decal making artist painted typical folk art pictures on coated papers. He then applied composite sheets in accordance with this invention, submerged these and washed away the pictures paper backings. The resultant decals were sold to visitors, who took the decal with them, and ironed them on to suitable substrates, after return to their home countries.

Ex. 3: A craft person made decals in accordance with this invention, which were trimmed and coated with acrylic emulsion over the decal rear sides. Simultaneously, wooden plaques were also coated with acrylic emulsion. When the coatings had dried, the decals were moistened and positioned on the coated plaques. They were slid into exact position, after which they were left to dry and adhere. A couple of hours later, the decals had all become integrated into the coating layer of the plaques.

Although the instant invention has been described in relation to particular embodiments thereof, many other variations and modifications and other uses will become apparent to those skilled in the art.

What is claimed is:

1. A image transfer decal composite sheet comprising:
a support sheet;
a release layer;
a plastic film releasably attached to said support sheet by said release layer;
a rubber-based hot melt adhesive layer adhered to said plastic film; and
a protective liner releasably adhered to said rubber-based hot melt adhesive layer.

2. A method of making a decal using an image transfer decal composite sheet; the method comprising the steps of:
obtaining an image transfer decal composite sheet having a support sheet, a release layer, a plastic film releasably attached to said support sheet by said release layer, a rubber-based hot melt adhesive layer adhered to said plastic film and a protective liner releasably adhered to said rubber-based hot melt adhesive layer;
removing said protective liner;
placing exposed said rubber-based hot melt adhesive layer in contact with a selected image located on a non-coated side of a single-side coated paper;
removing said support sheet by peeling therein along said release layer;
submerging the previous step resultant composite in a liquid; and
removing said paper leaving said image adhered to said hot-melt based rubber adhesive layer and protected by said coating thereby producing said decal.

3. A method of making a decal using an image transfer decal composite sheet according to claim 2; the method further comprising the step of coating said decal with a protective coating.

4. A method of making a decal using an image transfer decal composite sheet according to claim 2; the method further comprising the step of transferring said decal to a selected substrate using a iron.

5. A method of making a decal using an image transfer decal composite sheet according to claim 3 wherein said protective coating is an acrylic emulsion.

6. A method of making a decal using an image transfer decal composite sheet according to claim 4 wherein said selected substrate is cloth.

7. A method of making a decal using an image transfer decal composite sheet according to claim 2; the method further comprising the step of trimming said decal.

8. A method of making a decal using an image transfer decal composite sheet according to claim 2; the method further comprising the step of applying a powder to said decal whereby said decal is rendered non-sticky.
